(19) United States
(12) Patent Application Publication
(10) Pub. No.: US 2022/0341394 A1
(43) Pub. Date: Oct. 27, 2022

(54) ARTIFICIAL WIND GENERATORS IN AN ENCLOSED WIND MOTOR GENERATOR POWER PLANT FACILITY TO PRODUCE CONSISTENT ELECTRICITY OUTPUT

(71) Applicant: ROGELIO TIMBOL SERAFICA, MAKATI (PH)

(72) Inventor: ROGELIO TIMBOL SERAFICA, MAKATI (PH)

(21) Appl. No.: 17/811,887

(22) Filed: Jul. 12, 2022

(51) Int. Cl. F03D 9/39

(52) U.S. Cl. CPC F03D 9/39; F05B 2240/9112; F05B 2260/60

(57) ABSTRACT

The process involves the creation of an artificial wind within a covered and enclosed powerplant facility in order to initiate the mechanism to rotate several wind motor generators to induce and generate consistent electricity output. A covered plant facility houses multiple wind generators arranged in a random sequence to gain more wind sweep from each turbine of the wind generators. Several powerful blower fans act as prime movers to push atmospheric air inside the wind plant facility. Artificial wind within the facility is thus pushed, controlled, generated and mimics the outside atmospheric condition. A compact wind power generator covered facility shall house several motor wind aerodynamically designed turbines to induce controlled artificial wind condition pushed by powerful blower fans and transfer of energies from mechanical to electric energy to produce consistent and efficient electricity output from several generators lacking in conventional outdoor open air wind farm.

### BACKGROUND OF THE INVENTION

The invention involves the process of a wind generator system where wind is artificially induced and pushed to generate force, thrust and torque to rotate the turbine blades of several motor generators inside a contained and enclosed powerplant electric facility. Prime movers either dual or multiple electric motor turbine blower fans would push the air inside the facility to provide needed force to rotate the wind motor generators inside the enclosed aerodynamic structure made up of strong material of steel or concrete. An artificially controlled wind force is thus generated wherein changed in atmospheric outdoor condition occurs inside the confined powerplant facility by way of a program where prime movers are manipulated and controlled. For brevity, a given 20 kph outdoor wind velocity could be transformed into 80 kph inside the facility. Various aerodynamic motor turbine blower fans are utilized as prime movers positioned at the opening of the enclosed plant facility. The mechanisms to convert the kinetic wind energy ultimately to produce electrical energy coming from the pushed air and transferred to multiple wind motor generator inside the enclosure is triggered. This transfer of energies is almost similar in mechanism to an open field type wind farm generator system except the claimed system is in an enclosed facility and atmospheric condition is controlled such as wind velocity, temperature and consistent electricity generation output.

This will result in greater electrical energy efficiency and harvest up to 70% as against the conventional open environment wind or solar power generation system which produces total average electrical yield efficiency between 20% to 30%. Huge towers, complicated control systems due to wind inconsistent condition, heavy lifts and logistics are substantially minimized therefore cost is altogether reduced. Small and compact wind power plant facility gives the system higher advantage against the open conventional wind farm generators.

### DETAILED DESCRIPTION OF THE INVENTION

The process system would start from the electrical blower turbine fan motors 1 to push the atmospheric air inside the contained and enclosed powerplant facility 2. A more environment friendly zero emission rechargeable battery-run AC/DC prime mover 3 is utilized but not limited thereto. Within the enclosed facility are multiple wind type generators (WTG) 4 having aerodynamically designed turbine pitch-angled at 15° 5 to receive the artificially induced pushed air inside the wind enclosure to generate consistent and predictable electricity output. The pushed air would exit at the end opening or outlet 6 of the enclosed facility.

The multiple motor wind type generators could be arranged in an alternate row and random formations at a distance of 10 meters each wind generator as shown in FIG. 1 in order for the turbines to capture the force of the artificial wind to provide the necessary power and move the air in a single unilateral direction to transfer power, force and torque to the motor induction generators inside the powerplant to be converted into electrical energy with an enhance efficiency from 50% up to 70%.

Each motor generator shall produce its own electrical output based on their capacities. When all of the motor generators have each received the mechanical energy and converted electrical energy combined electrical generator output shall generate a consistent, predictable and an increase in electrical energy output and efficiency.

All systems shall be connected to a high voltage cable 7 to the main control panel 8 including the battery 9 and charger 10 and the auxiliary control panel 11 attached further to the main or central panels and transformer 12 to deliver to a substation or electrical grid.

### BRIEF DESCRIPTION OF THE FIGURES

The drawings and figures are not on scale as these are only for presentation and understanding of the invention as reference to the detailed description of the invention.

FIG. 1 is a top view of the schematic design layout of the enclosed wind generator powerplant facility.

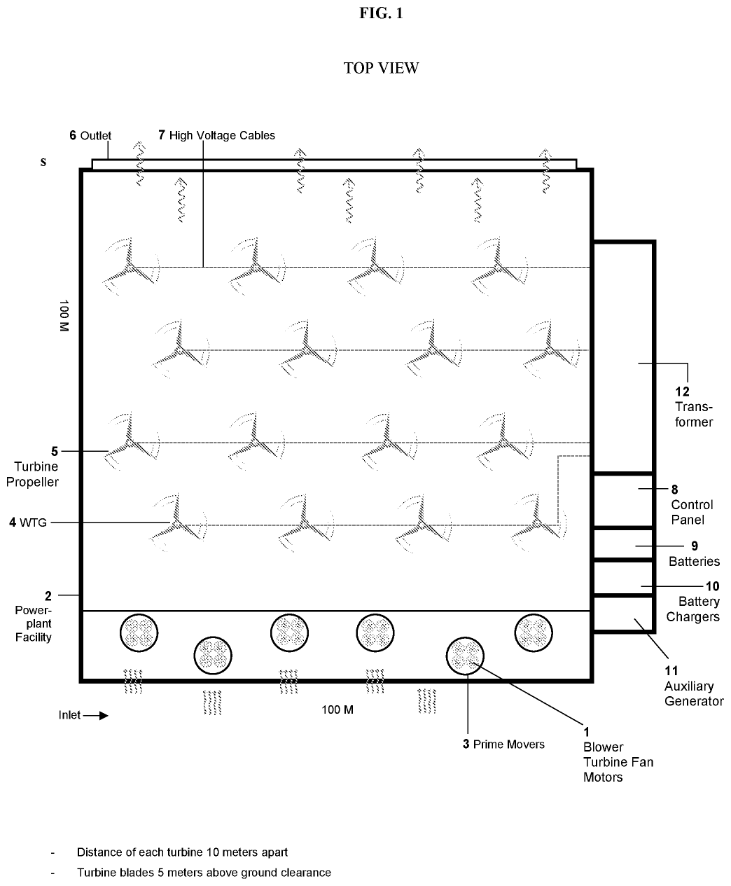

FIG. 2 is a front view of the enclosed wind generator powerplant facility.

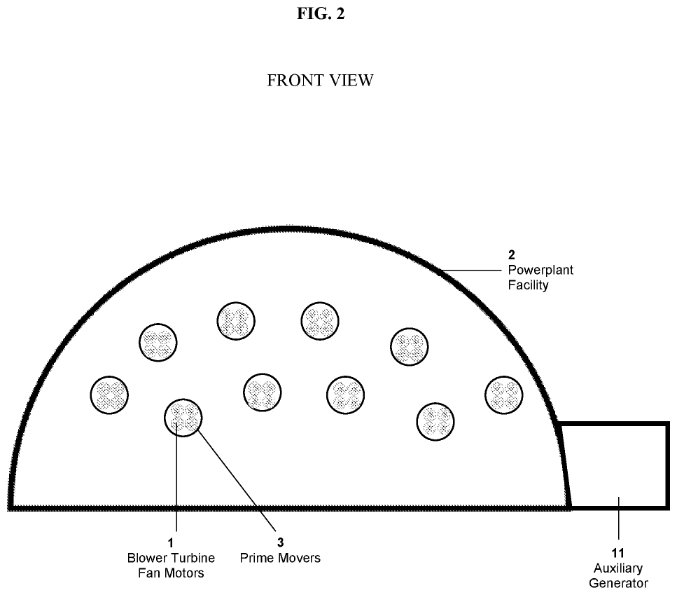

FIG. 3 shows the dimensions of the wind turbine generator (WTG) used inside the powerplant facility.

### DESCRIPTION OF EMBODIMENTS

Another embodiment on claim 1 is the primary control that starts from the number of prime movers either two or more of the prime movers to control speed or velocity to induce a wind moving at a minimum of 20 kilometers per hour up to 100 kilometers per hour. To achieve such a movement the turbines from the blower fans should rotate at a minimum revolutions per minute a speed control similar to an ordinary fan. Wind energy formula:

E=(½)×ρ×A×v3

ρ=air density

A=cross sectional area

V=wind velocity or speed

Air density is constant at 1.2 kg/m3 on a flat surface

The basic key point in calculating wind energy in a contained sheltered area and be able to control the wind velocity and air density is through manipulation of the prime movers. Since the prime movers would be able to deliver the necessary wind force and a speed controller mechanism in a control panel system either a step up or step down is installed. This will enable to determine and manipulate wind speed and force inside the covered and contained wind powerplant facility. All turbines will move in unison and synchronized manner without so much interference from lack of air density and weakened or stronger wind force from the natural wind environment which are mostly inconsistent, inefficient and unpredictable typical of an open outdoor wind farm. Wind control by way of a speed regulator from a main control panel makes it vital for a reliable delivery of the electricity generated from the various motor wind generators inside the indoor wind generator powerplant.

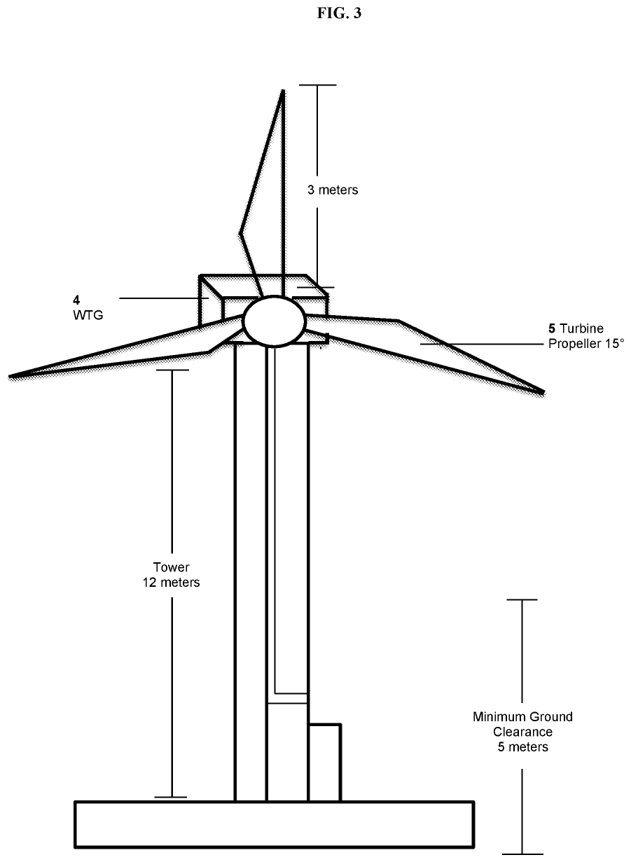

In one of the embodiment is a 3-meter shortened, curved and designed turbine blade which will be pitch-angled at 15° to minimize the drag in the angle of attack from the wind. Three blades at 15° configuration angle would compensate for the drag created by the friction of air against the blade surface. A pitch angled 15° curved with at least 3 blades would compensate for the drag but would decrease the angle of attack getting a smoother flow of the wind with a grater blade lift shown in FIG. 3 attached to the tower with a height on 12 meters and a minimum ground clearance of 5 meters.

In another embodiment part of claim 1, the detailed design of the covered, contained and aerodynamically plant facility has a big contribution to the efficiency to generate the artificial wind. One such design, but not limited to the exact area as illustrated, comes in an assumed 10,000 sqm of built-up power plant, with an area of 100 meters×100 meters configuration. Assuming that the distance in random sequence at a distance of 10 meters each wind generators apart from the closest turbines or propellers, 16 wind motor generation would fit inside the powerplant facility.

Assume each motor wind generator has 1 Megawatt capacity in a 10,000-Sqm covered facility a 16-Megawatt wind power generator electric powerplant would easily be generated using at least 6 or 10 power blower fan prime movers with a 5-horsepower capacity fed with a multi-fed electrical current either from lithium or nickel ion batteries, combustion gas engine or from an AC current grid electrical power source. Compared with the solar UV power generator a one hectare per megawatt is a regular space for solar panels as a rule of thumb. A built-up area of 10,000 sqm covered floor area is what it needs to generate at least 15 Megawatt to 16 Megawatt of consistent electrical output in an enclosed wind generator plant facility as embodied in this system.

1. I claim the embodiment of the process system and method of a multiple wind generator housed in a covered and enclosed powerplant facility. The process uses several designed blower fans as mechanical prime movers to create an artificial atmospheric wind condition inside the facility to trigger the operation of several wind motor generators in a compact and controlled environment to produce electrical energy. The embodiment or process induces a controlled artificial atmospheric wind condition such as velocity and temperature in a contained and enclosed powerplant facility grouping together in clusters several wind motor generators with compact turbines to produce and enhance, efficient, consistent and predictable electrically output not dependent on the unstable outside atmospheric condition typical of an outdoor wind farm power plant.
